(19) United States
(12) Patent Application Publication
(10) Pub. No.: US 2011/0076053 A1
(43) Pub. Date: Mar. 31, 2011

(54) IMAGE FORMING APPARATUS AND IMAGE FORMING METHOD

(75) Inventor: MASAKI KADOTA, OSAKA (JP)

(73) Assignee: KYOCERA MITA CORPORATION, Osaka (JP)

(21) Appl. No.: 12/892,860

(22) Filed: Sep. 28, 2010

(30) Foreign Application Priority Data
Sep. 29, 2009 (JP) 2009-225430

(51) Int. Cl. G03G 15/16

(52) U.S. Cl. 399/101

(57) ABSTRACT

An image forming apparatus includes: a photoreceptor; a charging portion; an exposure portion; a developing portion; a transfer body; a cleaning portion; and a control portion. The charging portion charges the photoreceptor. The exposure portion forms an electrostatic latent image on the photoreceptor. The developing portion forms a developed image on the photoreceptor. The developed image thus formed is primarily transferred to the transfer body and the transfer body secondarily transfers the developed image thus primarily transferred to a predetermined recording medium. The cleaning portion cleans the transfer body. The control portion performs control to: form a cleaning developed image on the photoreceptor outside of a paper feeding width and inside of a developing width, primarily transfer the cleaning developed image to the transfer body, and make the cleaning portion clean the cleaning developed image thus primarily transferred.

This application is based upon and claims the benefit of priority from the corresponding Japanese Patent Application No. 2009-225430 filed on 29 Sep. 2009, the entire content of which are incorporated herein by reference.

### BACKGROUND OF THE INVENTION

1. Field of the Invention

The present invention relates to an image forming apparatus and an image forming method.

2. Related Art

In an image forming apparatus using xerography, a charging device (charging portion) having a charging roller charges a photoreceptor drum (photoreceptor) and an exposure portion irradiates with light (exposes to light) a surface of the photoreceptor drum thus charged, thereby forming an electrostatic latent image (latent image) on the surface of the photoreceptor drum. In addition, a developing device (developing portion) supports toner (developer), and when a developing bias voltage is applied, the toner attaches to the electrostatic latent image to form a toner image (developed image). The toner image is primarily transferred to a transfer surface of an intermediate transfer body, and then secondarily transferred to and fixed onto paper (recording medium).

Here, a minute amount of toner may remain on the surface of the photoreceptor drum without being transferred to the paper and needs to be removed before subsequent image formation. The surface of the photoreceptor drum is cleaned using a cleaning blade. However, abrasion by cleaning of the surface greatly influences the lifetime of the photoreceptor drum. Given this, a configuration aiming at prolonging the lifetime of the photoreceptor drum is disclosed.

Hereinafter, a length in a rotational axis direction of a region to be charged (in other words, a width of the charging roller) is referred to as a charging width, a length in the rotational axis direction of a region in which development is performed (in other words, a width of the developing roller) is referred to as a developing width, and a length in the rotational axis direction of a region corresponding to a region through which the paper passes is referred to as a paper feeding width. A region outside of the paper feeding width is a range in which an image is not formed. This is because, in the region outside of the paper feeding width, the surface of the photoreceptor drum does not contact the paper, even if it is the transfer surface. In order to form a toner image also in right and left edges of the paper, the developing width needs to be greater than the paper feeding width. The charging width is set to be greater than the developing width. This is because, if the charging width is smaller than the developing width, toner would continue to attach to a region outside of the charging width.

In other words, by applying the developing bias voltage, although toner (including an external additive) is directed toward the region outside of the paper feeding width and inside of the developing width of the photoreceptor drum, the region corresponds to a region inside of the charging width. As a result, the toner itself does not attach to the surface of the photoreceptor drum and returns to the developing device. On the other hand, the external additive included in the toner is detached from the toner and left in the region. Thereafter, only the external additive is transferred from the surface of the photoreceptor drum to the transfer surface of the intermediate transfer body.

Here, cleaning of the transfer surface in a state where only the external additive has been transferred thereto is difficult with a cleaning apparatus of the intermediate transfer body. In addition, due to a slight difference in linear velocity between the intermediate transfer body and the photoreceptor drum, the region outside of the paper feeding width and inside of the developing width on the surface of the photoreceptor drum, which has contacted the transfer surface of the intermediate transfer body, is abraded with the external additive. As a result, there is a problem of reduced lifetime of the photoreceptor drum due to the abrasion of the region on the photoreceptor drum.

Accordingly, the abovementioned conventional art has a problem of abrasion of the surface of the photoreceptor drum by the transfer surface of the intermediate transfer body.

### SUMMARY OF THE INVENTION

Given this, the present invention is made in view of the abovementioned problems to provide an image forming device that prevents abrasion of a surface of a photoreceptor drum by a transfer surface of an intermediate transfer body.

An image forming apparatus according to an aspect of the present invention includes: a photoreceptor; a charging portion; an exposure portion; a developing portion; a transfer body; a cleaning portion; and a control portion. The charging portion charges the photoreceptor. The exposure portion forms an electrostatic latent image on the photoreceptor by exposing the photoreceptor that has been charged. The developing portion forms a developed image on the photoreceptor by developing the electrostatic latent image thus formed by a developer containing an external additive. The developed image thus formed is primarily transferred to the transfer body and the transfer body secondarily transfers the developed image thus primarily transferred to a predetermined recording medium. The cleaning portion cleans the transfer body after the developed image is secondarily transferred to the recording medium. The control portion performs control to: form a cleaning developed image on the photoreceptor outside of a paper feeding width and inside of a developing width in a rotational axis direction of the photoreceptor, primarily transfer the cleaning developed image to the transfer body, and make the cleaning portion clean the cleaning developed image thus primarily transferred.

An image forming method according to an aspect of the present invention includes steps of:

charging a photoreceptor;

forming an electrostatic latent image on the photoreceptor by exposing the photoreceptor that is charged;

forming a developed image on the photoreceptor by developing the electrostatic latent image thus formed by a developer containing an external additive; primarily transferring the developed image thus formed to a transfer body;

secondarily transferring the developed image thus primarily transferred to a predetermined recording medium;

cleaning the transfer body after the developed image is secondarily transferred to the recording medium;

forming a cleaning developed image on the photoreceptor outside of a paper feeding width and inside of a developing width in a rotational axis direction of the photoreceptor; primarily transferring the cleaning developed image thus formed to the transfer body; and

making the cleaning portion clean the cleaning developed image thus primarily transferred.

### BRIEF DESCRIPTION OF THE DRAWINGS

FIG. 1 is a cross-sectional view schematically showing a configuration of a printer according to the present embodiment;

FIG. 2 is a block diagram of the printer of FIG. 1;

FIG. 3 is a cross-sectional view of the vicinity of an image forming unit of FIG. 1;

FIG. 4 is an explanatory diagram of the widths of a photoreceptor drum, an intermediate transfer belt, a charging roller, and a developing roller of FIG. 3; and

FIG. 5 is an explanatory diagram of a cleaning toner image to be transferred to the intermediate transfer belt of FIG. 3.

### DETAILED DESCRIPTION OF THE INVENTION

A preferred embodiment of the present invention is described hereinafter with reference to the drawings.

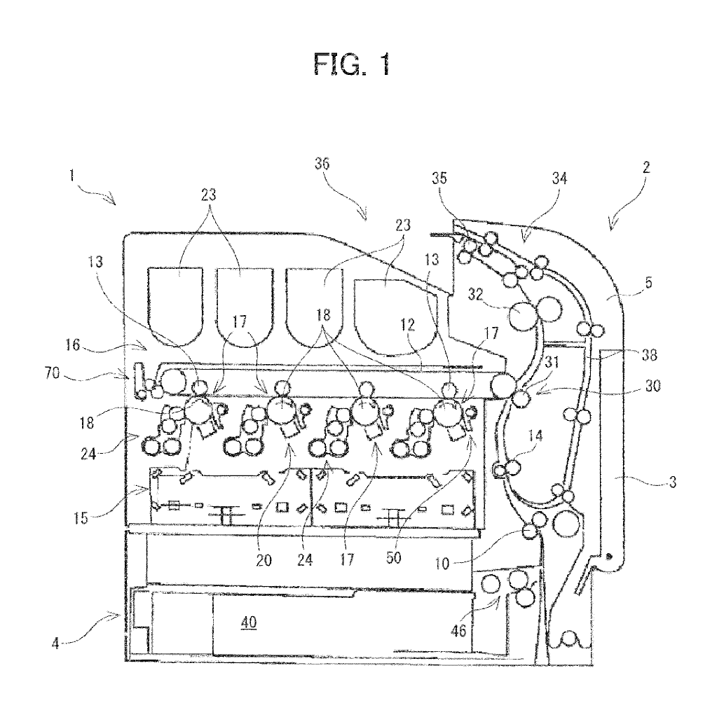

FIG. 1 schematically shows a configuration of a printer 1 that can perform color printing as an example of the image forming apparatus. A cross section shown in FIG. 1 is taken from a left side face of the printer 1. Accordingly, a front face of the printer 1 is shown on a right side and a back face thereof is shown on a left side in FIG. 1.

As shown in FIG. 1, an ejected paper tray 36 is provided on an upper side of an apparatus main body 2 of the printer 1. A plurality of operation keys for various operations by a user and a front cover 5 on which a display for displaying a variety of information is provided in the vicinity of the ejected paper tray 36.

In addition, a paper feeding cassette 4 is disposed on a lower side of the apparatus main body 2. In a storage portion 40 thereof, sheets of paper as an example of the recording medium are stored in a stacked state. On an upper right side of the storage portion 40 in FIG. 1, a roller 46 is provided.

The paper is fed toward an upper right side of the paper feeding cassette 4 in FIG. 1. Subsequently, the paper thus fed is conveyed upward inside the apparatus main body 2, along a front face of the printer 1.

In addition, the paper feeding cassette 4 is configured to be slidable toward the front face of the printer 1, in other words toward a right side in FIG. 1. In such a state of the paper feeding cassette 4 having been slid outwards, replenishment and exchange of the paper in the storage portion 40 is possible.

Inside of the apparatus main body 2, a conveyance roller 10, a resist roller 14, an image forming portion 16 and a transfer portion 30 are disposed in this order on a downstream side of the paper feeding cassette 4 in a paper conveying direction.

In the image forming portion 16, four image forming units 17 are disposed in parallel.

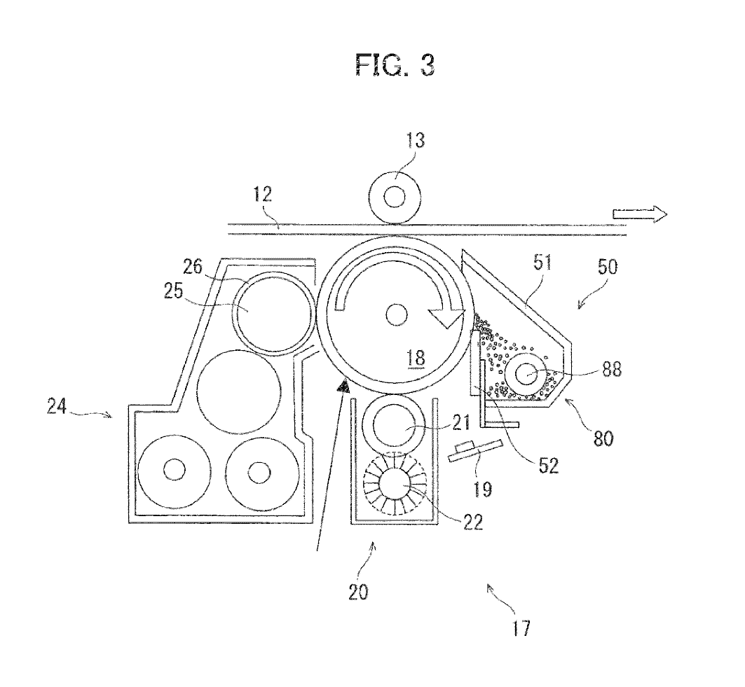

In each image forming unit 17, a photoreceptor drum (photoreceptor) 18 is provided (see FIGS. 1 and 3). The photoreceptor drum 18 is rotatably disposed. The photoreceptor drum 18 is driven clockwise in FIGS. 1 and 3 by a drive motor (not shown).

The photoreceptor drum 18 of the present embodiment is formed to be 30 mm in diameter, for example. The photoreceptor drum 18 is an OPC drum having an organic layer on a surface thereof.

In addition, an exposure portion 15 is provided between the photoreceptor drum 18 and the paper feeding cassette 4. Laser light is emitted from the exposure portion 15 toward each photoreceptor drum 18. In addition, as shown in FIGS. 1 and 3, a charging device (charging portion) 20, a developing device (developing portion) 24, an intermediate transfer roller 13 and a cleaning portion 50 are provided at arbitrary positions on the periphery of each photoreceptor drum 18.

The charging device 20 is positioned in a lower portion of the image forming unit 17, as shown in FIG. 3. The charging device 20 includes a charging roller 21 and a friction roller 22. The photoreceptor drum 18 contacts the charging roller 21. The friction roller 22 is provided with a brush to abrade and clean a surface of the charging roller 21 by friction. The charging device 20 charges the surface of the photoreceptor drum 18. The charging roller 21 is, for example, made of epichlorohydrin rubber and formed to be 12 mm in diameter.

In addition, the developing device 24 is disposed to the left side of the image forming unit 17. The developing device 24 has a developing roller 25 that faces the photoreceptor drum 18.

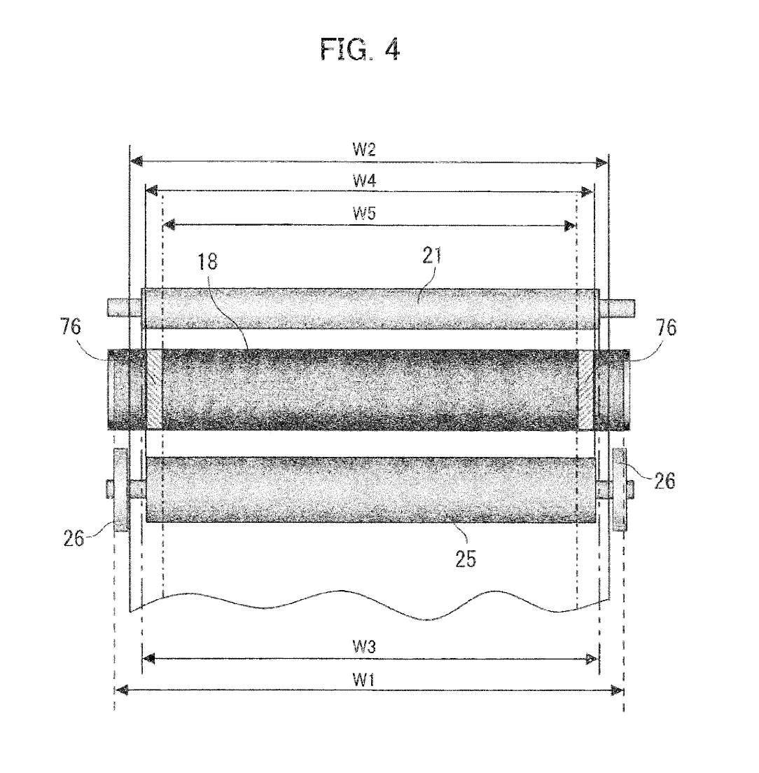

The developing roller 25 is driven counterclockwise in FIG. 3 by a drive motor (not shown). It should be noted that a gap control roller 26 is provided in both ends of the developing roller 25 (FIG. 4). The gap control roller 26 rotates according to rotation of the photoreceptor drum 18 and sets a gap between the developing roller 25 and the photoreceptor drum 18.

The image forming portion 16 includes an intermediate transfer belt (transfer body) 12 made of rubber. The intermediate transfer belt 12 is disposed above each photoreceptor drum 18. Between the intermediate transfer belt 12 and the ejected paper tray 36, four toner containers 23 are disposed (FIG. 1). The toner containers 23 are disposed in an order of magenta, cyan, yellow, and black from a back side to a front side of the printer 1. The container for black ink is configured to be the largest in capacity.

The transfer portion 30 is provided with a transfer roller 31. The transfer roller 31 is configured to be able to be in pressure-contact against the intermediate transfer belt 12 from an obliquely lower side.

In addition, the intermediate transfer belt 12 and the transfer roller 31 form a nip portion for transferring a toner image (developed image), which is formed by the toner (developer) supplied from the four toner containers 23, to the paper.

In addition, on a downstream side of the transfer portion 30 in the paper conveying direction, a fixing portion 32, an ejection branch portion 34 and the ejected paper tray 36 are disposed in this order.

In the present embodiment, a duplex printing paper path 38 is formed between the transfer portion 30 and a manual feeding tray 3. The duplex printing paper path 38 branches off from the ejection branch portion 34 on a front face side of the apparatus main body 2, and extends downward to connect to an upstream side of the resist roller 14.

Here, a minute amount of external additive (titanium oxide, silica, alumina and the like) is added to the toner of the present embodiment. As shown in FIG. 3, the above-mentioned cleaning portion 50 is provided with a housing 51 having an opening directed toward the photoreceptor drum 18, on a downstream side of a transfer position of the intermediate transfer roller 13 in a rotational direction of the photoreceptor drum 18. The cleaning portion 50 includes a cleaning blade 52 and a toner collection portion 80 at appropriate positions in the housing 51.

More specifically, the cleaning blade 52 is composed of a zinc steel plate main body fixed in a lower end of the housing 51 and a blade portion made of polyurethane rubber adhered to the main body. An edge of the blade portion of the cleaning blade 52 extends along a rotational axis of the photoreceptor drum 18, at a position lower than the rotational axis of the photoreceptor drum 18. The edge contacts the surface of the photoreceptor drum 18 and scrapes residual toner including the external additive and a discharge product that are attached to the surface of the photoreceptor drum 18.

The residual toner and the like scraped from the surface of the photoreceptor drum 18 by the cleaning blade 52 are collected into the toner collection portion 80.

More specifically, the toner collection portion 80 has a screw 88 in the vicinity of the bottom face of the housing 51. The screw 88 is disposed on a right side of the cleaning blade 52 in FIG. 3. The screw 88 extends in a rotational axis direction of the photoreceptor drum 18. The tip end of the screw 88 is connected to a drive motor (not shown). When the drive motor operates, the residual toner and the like inside the housing 51 are collected into a collection container via the screw 88.

On the other hand, the abovementioned intermediate transfer belt 12 is cleaned by the cleaning portion 70.

The cleaning portion 70 of the present embodiment is provided on the intermediate transfer belt 12 on an opposite side to the pressure-contact position between the intermediate transfer belt 12 and the transfer roller 31 (FIG. 1).

More specifically, the cleaning portion 70 is provided on an upstream side in a running direction of the intermediate transfer belt 12 of the image forming unit 17 for magenta, which is disposed on a back side of the printer 1. The cleaning portion 70 includes a cleaning roller, a blade and the like.

The cleaning roller is formed of a brush made of electrically conductive nylon. The cleaning roller is rotated by a drive motor (not shown), and contacts and cleans the transfer surface of the abovementioned intermediate transfer belt 12 made of rubber.

The cleaning roller thus removes the residual toner including the external additive adhered to the transfer surface of the intermediate transfer belt 12, paper dust generated from the paper and the like, thereby cleaning the transfer surface of the intermediate transfer belt 12. In addition, the blade scrapes the toner and the like by contacting the cleaning roller. The toner that is scraped away from the cleaning roller is collected into another collection container by using, for example, a feeding roller.

Incidentally, in the image forming unit 17 of the present embodiment, as shown in FIG. 4, when rotational axes are aligned, a drum width W1 that is a width of the photoreceptor drum 18, an intermediate transfer belt width W2 that is a width of the intermediate transfer belt 12, a charging width W3 that is a width of the charging roller 21 (i.e. a length in a rotational axis direction of a region to be charged on the surface of the photoreceptor drum 18), a developing width W4 that is a width of the developing roller 25 (i.e. a length in the rotational axis direction of a region in which development is performed on the surface of the photoreceptor drum 18), and a paper feeding width W5 that is a length in the rotational axis direction of a region corresponding to a region through which the paper passes are not equal.

More specifically, as shown in FIG. 4 illustrating a relationship between the widths of the components, the drum width W1 shown by dashed lines in FIG. 4 is configured to be greater than or equal to the intermediate transfer belt width W2 shown by solid lines in FIG. 4.

In addition, the intermediate transfer belt width W2 is configured to be greater than or equal to the charging width W3 shown by two-dot dashed lines in FIG. 4. Furthermore, the charging width W3 is configured to be greater than or equal to the developing width W4 shown by solid lines in FIG. 4. This is because, if the charging width W3 is smaller than the developing width W4, toner would continue to attach to a region outside of the charging width W3.

Moreover, the developing width W4 is always configured to be greater than the paper feeding width W5 shown by dashed-dotted lines in FIG. 4. This is for forming a toner image also in right and left edges of the paper.

In other words, on the surface of the photoreceptor drum 18, a region outside of the paper feeding width W5 in a rotational axis direction of the photoreceptor drum 18 does not contact the paper, even if it is the transfer surface of the intermediate transfer belt 12. Therefore, an image is not formed in the region.

However, by applying a developing bias voltage, the toner including the external additive is directed also toward a region inside of the developing width W4 shown by the solid lines in FIG. 4 (a non-image region 76 marked by diagonal lines in FIG. 4), which is a region outside of the paper feeding width W5 shown by the dashed-dotted lines.

Among the toner directed toward the non-image region 76, the toner itself does not attach to the surface of the photoreceptor drum 18 and returns to the developing device 24. This is because the non-image region 76 corresponds to the region inside of the charging width W3 shown by the two-dot dashed lines in FIG. 4.

On the other hand, among the toner directed toward the non-image region 76, the external additive is detached from the toner and left in the non-image region 76. Thereafter, only the external additive is transferred from the surface of the photoreceptor drum 18 to the transfer surface of the intermediate transfer belt 12, and the non-image region 76 of the photoreceptor drum 18, which contacts the transfer surface a subsequent time, is abraded by the external additive.

In addition, the non-image region 76 that is abraded by the external additive is formed on all the photoreceptor drums 18 for magenta, cyan, yellow, and black.

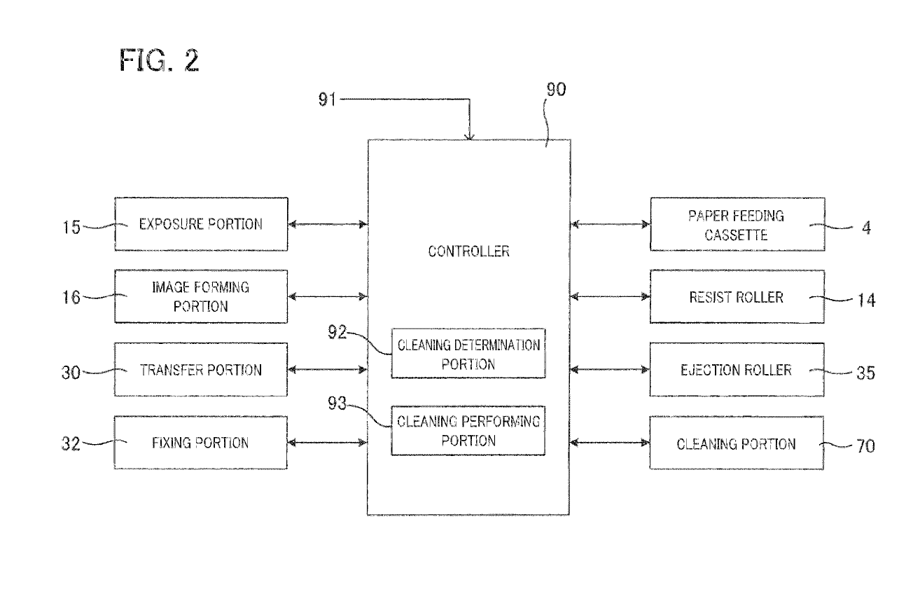

Given this, a new toner image is formed in the non-image region 76 in the present embodiment. This is performed in response to a drive signal from a controller (control portion) 90 shown in FIG. 2.

More specifically, the controller 90 includes a cleaning determination portion 92 and a cleaning performing portion 93. The cleaning determination portion 92 determines whether or not having reached a predetermined number of sheets (for example, 500 sheets) for which there is concern of abrasion by the external additive. The cleaning determination portion 92 outputs a result of the determination to the cleaning performing portion 93.

For example, in a case where the cleaning determination portion 92 determines that printing of 120 sheets of paper has finished, the cleaning performing portion 93 does not output a drive signal to the image forming unit 17 since the concern of abrasion by the external additive is small.

On the contrary, in a case where the cleaning determination portion 92 determines that printing of 500 sheets of paper has finished, for example, the cleaning performing portion 93 of the present embodiment outputs a drive signal to the image forming unit 17 for black and the cleaning portion 70.

More specifically, in the image forming unit 17 for black, the charging roller 21 thereof charges the surface of the photoreceptor drum 18. The exposure portion 15 irradiates the non-image region 76 of the photoreceptor drum 18 with laser light (exposes the photoreceptor drum 18) at a timing at which the toner image for printing on paper is not formed on the surface of the photoreceptor drum 18, i.e. between an image for the present sheet of paper and an image for the next sheet of paper. In other words, the exposure portion 15 extends an irradiation range of the laser light to the region outside of the paper feeding width W5 shown by the dashed-dotted lines in FIG. 4. Thereafter, the image forming unit 17 for black forms an electrostatic latent image (a cleaning electrostatic latent image) on the surface of the photoreceptor drum 18 for a solid image (a toner image formed on the entire non-image region 76).

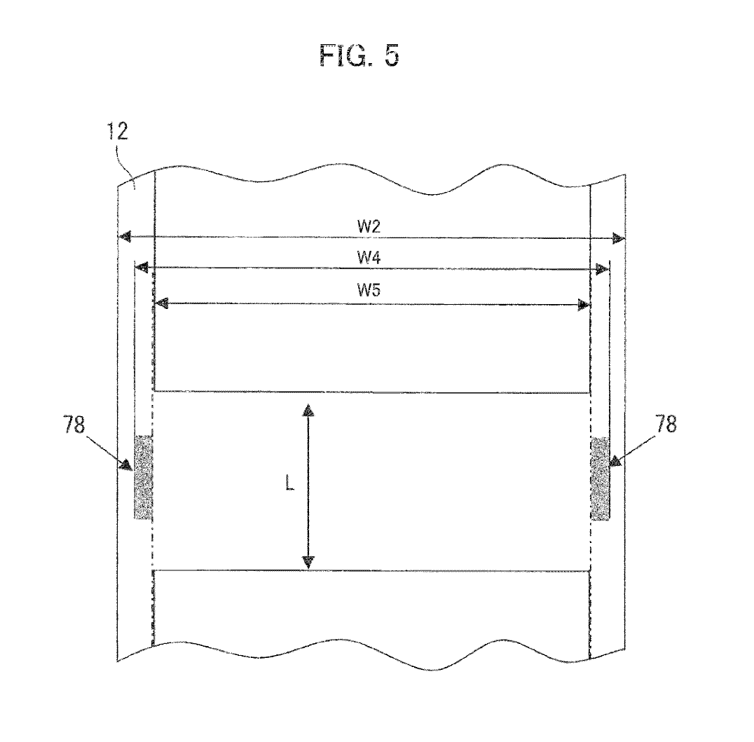

Subsequently, the toner from the developing roller 25 is attached to the electrostatic latent image for the solid image formed on the surface of the photoreceptor drum 18. In addition, a bias voltage that directs the toner image from the photoreceptor drum 18 to the intermediate transfer belt 12 is applied to the intermediate transfer roller 13. As a result, on the transfer surface of the intermediate transfer belt 12, between the image for the present sheet of paper and the image for the next sheet of paper (a range of an interpaper region L in FIG. 5 on the transfer surface of the intermediate transfer belt 12), two cleaning toner images (cleaning electrostatic latent images) 78 are transferred.

On the other hand, a bias voltage of the reverse polarity to a bias voltage that directs the toner image from the intermediate transfer belt 12 to the transfer roller 31 is applied to the transfer roller 31 of the transfer portion 30.

As a result, the cleaning toner images 78 reach the cleaning portion 70 without moving toward the transfer roller 31. Thereafter, the cleaning toner images 78 are cleaned by the brush-shaped cleaning roller in the cleaning portion 70. It should be noted that the cleaning roller is formed with a width greater than the developing width W4 shown by solid lines in FIG. 5.

As shown in FIG. 1, when the printer 1 performs printing, the paper is fed from the paper feeding cassette 4 in a state of being separated one by one by the roller 46. The paper thus fed reaches the resist roller 14. The resist roller 14 waits for a timing for transfer of the toner image formed in the image forming portion 16 and feeds the paper to the transfer portion 30 at a predetermined feed timing, while correcting a skew of the paper.

On the other hand, an input port 91 in FIG. 2 is configured to be able to receive image data for printing from the outside. The image data is data of various images such as letters, symbols, figures, signs, diagrams and patterns. The controller 90 controls emission of light and the like based on the data.

More specifically, an eraser lamp 19 is turned on for each photoreceptor drum 18 (FIG. 3). Thereafter, the charging device 20 charges the surface of each photoreceptor drum 18. Next, the exposure portion 15 irradiates the surface of the photoreceptor drum 18 with laser light. An electrostatic latent image is thus formed on the surface of each photoreceptor drum 18. Toner images of each color are formed from the electrostatic latent image.

Each toner image is secondarily transferred to the paper in the transfer portion 30. It should be noted that the residual toner on the surface of the photoreceptor drum 18 is removed by the cleaning portion 50. In addition, the residual toner on the surface of the intermediate transfer belt 12 is removed by the abovementioned cleaning portion 70.

Subsequently, the paper is fed toward the fixing portion 32 in a state of supporting an unfixed toner image. In the fixing portion 32, the toner image is fixed by heating and pressurizing. Thereafter, the paper fed from the fixing portion 32 is ejected to the ejected paper tray 36 via an ejection roller 35. The paper ejected to the ejected paper tray 36 is stacked in a height direction in the ejected paper tray 36.

Unlike this single-side printing, in duplex printing, a conveying direction of the paper ejected from the fixing portion 32 is switched at the ejection branch portion 34. In other words, the paper printed on one side is returned into the apparatus main body 2 and conveyed to the duplex printing paper path 38. Next, the paper is fed toward the upstream side of the resist roller 14. Then, the paper is fed again toward the transfer portion 30. As a result, a toner image is transferred to an unprinted side of the paper.

Incidentally, the cleaning determination portion 92 and the cleaning performing portion 93 of the above-mentioned embodiment control the image forming unit 17 for black based on the number of printed sheets, such that the cleaning toner image 78 is formed on the photoreceptor drum 18. As a result, the cleaning toner image 78 is formed by the image forming unit 17 for black. However, the cleaning toner image 78 can be formed either by any of the image forming units 17 for magenta, cyan and yellow, or sequentially by these image forming units 17.

Alternatively, in addition to the control based on the number of printed sheets, the cleaning determination portion 92 and the cleaning performing portion 93 can perform control based on a result of measurement of the transfer surface of the intermediate transfer belt 12 by a color density sensor.

In addition, in a case where the cleaning determination portion 92 determines that a printing job is terminated, the cleaning performing portion 93 can output a drive signal to the image forming unit 17 and the cleaning portion 70. In other words, in addition to a timing between sheets of paper, a timing after termination of a printing job also corresponds to a case of not forming the toner image for printing on the paper on the surface of the photoreceptor drum 18.

As described above, according to the present embodiment, in the plurality of image forming units 17, toner images developed by the toners of respective colors from the latent images formed on the surface of each of the photoreceptor drums 18 are respectively formed on the surface thereof. The intermediate transfer belt 12 overlaps these respective toner images on the transfer surface (primary transfer), and then transfers the toner image onto the paper (secondary transfer). Thereafter, the cleaning portion 70 cleans the toner remaining on the transfer surface. The transfer surface thus cleaned is used for the next primary transfer.

Here, even when the developing bias voltage is applied, the toner itself in the non-image region 76 in FIG. 4 (a region outside of the paper feeding width W5 and inside of the developing width W4) does not attach to the surface of the photoreceptor drum 18.

On the other hand, the external additive is detached from the toner and left in the non-image region 76. Only the external additive is transferred from the surface of the photoreceptor drum 18 to the transfer surface of the intermediate transfer belt 12. This phenomenon can be determined from a white band appearing on the transfer surface along a circumferential direction thereof.

In a region with the white band, abrasion performance is high. As a result, the region with the white band abrades the non-image region 76 of the photoreceptor drum 18 more than the region inside of the paper feeding width W5.

In the present embodiment, the controller 90 forms the cleaning toner image 78 on the non-image region 76, thereby applying the toner to a region where only the external additive is present. The external additive can be cleaned by the cleaning portion 70 when the toner itself is present. Thereafter, the controller 90 transfers (primarily transfers) the cleaning toner image 78 onto the transfer surface of the intermediate transfer belt 12. The controller 90 makes the cleaning portion 70 clean the cleaning toner image 78 without secondarily transferring onto the paper.

Accordingly, the surface of the photoreceptor drum 18 is not easily abraded by the external additive. This can realize prolonging of the lifetime of the photoreceptor drum 18. As a result, superior image formation can be performed for an extended period of time and the reliability of the printer 1 can be improved.

In addition, the charging device 20 of contact charging type does not generate much ozone or nitrogen oxide compared to the corona discharge type charging device, thereby improving image quality. However, even in the non-image region 76 of the photoreceptor drum 18, the charging roller 21 applies voltage to the photoreceptor drum 18 by directly contacting the surface thereof.

In other words, leak occurs in the non-image region 76 due to intolerance to the voltage. Therefore, an electric current leaks outwards and a central portion of the surface of the photoreceptor drum 18 is not charged. This results in irregularity in an image such as a black band in a horizontal direction. However, by forming the abovementioned cleaning toner image 78, leaks can be avoided even when using the charging device 20 of contact charging type.

In addition, the surface of the photoreceptor drum 18, which is an OPC drum, is particularly easily abraded. Accordingly, abrasion by the external additive may greatly influence the photoreceptor drum 18. However, by using the abovementioned cleaning toner image 78, the characteristics of the photoreceptor drum 18 can be maintained for an extended period of time and a remarkable effect can be provided.

Furthermore, by using the intermediate transfer belt 12 made of rubber, drop off of letters during transfer can be prevented. Since the toner itself is applied to the region where only the external additive is present, as described above, there is no risk of adhesion of the external additive.

In addition, since irradiation from the exposure portion 15 is extended to the region outside of the paper feeding width W5, a latent image for the cleaning toner image 78 can be accurately formed.

The present invention is not limited to the abovementioned embodiment and can be modified in various ways without departing from the scope of the claims.

For example, the cleaning toner image 78 for the subsequent time can be formed in an interpaper region that is different from that of the present time. More specifically, by consecutively forming the cleaning toner image 78 between an X^{th} sheet and an x+1^{th} sheet this time, between the x+1^{th} sheet and an x+2^{th} sheet next time and the like, the cleaning toner image 78 moves in a running direction of the intermediate transfer belt 12. In such a way, the cleaning toner image 78 can be formed on the entire circumference of the intermediate transfer belt 12. In other words, since the above-mentioned white band appearing on the transfer surface along the circumferential direction thereof can be entirely covered, abrasion of the photoreceptor drum 18 can be avoided more reliably.

In addition, in the above embodiment, the cleaning toner image 78 is formed only in the non-image region 76. However, in the region inside of the paper feeding width W5 shown by the dotted-dashed lines in FIG. 4, belt-shaped toner images may be consecutively formed along the rotational axis direction of the photoreceptor drum 18, in addition to the cleaning toner images 78.

Furthermore, in the above embodiment, the toner image is transferred to the intermediate transfer belt 12 above the photoreceptor drum 18; however, the toner image can be transferred to the intermediate transfer belt 12 below the photoreceptor drum 18.

Moreover, in the above embodiment, the printer 1 is exemplified as the image forming apparatus. However, the image forming apparatus according to the present invention can naturally be applied to a multi-functional printer, a copy machine, a facsimile machine and the like.

In any of these cases, as in the abovementioned case, an effect of avoiding abrasion of the surface of the photoreceptor drum 18 by the transfer surface of the intermediate transfer belt 12 can be exerted.

What is claimed is:

1. An image forming apparatus comprising:
a photoreceptor;
a charging portion that charges the photoreceptor;
an exposure portion that forms an electrostatic latent image on the photoreceptor by exposing the photoreceptor that is charged;
a developing portion that forms a developed image on the photoreceptor by developing the electrostatic latent image thus formed by a developer containing an external additive;
a transfer body to which the developed image thus formed is primarily transferred, and that secondarily transfers the developed image thus primarily transferred to a predetermined recording medium;
a cleaning portion that cleans the transfer body after the developed image is secondarily transferred to the recording medium; and
a control portion that performs control to: form a cleaning developed image on the photoreceptor outside of a paper feeding width and inside of a developing width in a rotational axis direction of the photoreceptor, primarily transfer the cleaning developed image to the transfer body, and
make the cleaning portion clean the cleaning developed image thus primarily transferred.

2. The image forming apparatus according to claim 1, wherein the charging portion charges the photoreceptor by contacting a surface of the photoreceptor.

3. The image forming apparatus according to claim 1, wherein the photoreceptor includes an organic-based layer on a surface of the photoreceptor.

4. The image forming apparatus according to claim 3, wherein the transfer body is configured by a band-shaped belt made of rubber.

5. The image forming apparatus according to claim 1, wherein the control portion performs control to primarily transfer the cleaning developed image to the transfer body such that a position of the cleaning developed image on the transfer body moves in a moving direction of the transfer body.

6. The image forming apparatus according to claim 1, wherein the exposure portion forms a cleaning electrostatic latent image by exposing a surface of the photoreceptor outside of a paper feeding width and inside of a developing width in a rotational axis direction of the photoreceptor.

7. The image forming apparatus according to claim 6, wherein, in a case of an output number of the recording medium having reached a predetermined value, the control portion controls the exposure portion to form the cleaning electrostatic latent image by exposing the surface of the photoreceptor outside of the paper feeding width and inside of the developing width in the rotational axis direction of the photoreceptor.

8. The image forming apparatus according to claim 1, wherein the control portion performs control to make the cleaning portion clean the transfer body without secondarily transferring the cleaning developed image, which is primarily transferred to the transfer body, to the predetermined recording medium.

9. An image forming method comprising the steps of:
charging a photoreceptor;
forming an electrostatic latent image on the photoreceptor by exposing the photoreceptor that is charged;
forming a developed image on the photoreceptor by developing the electrostatic latent image thus formed by a developer containing an external additive;
primarily transferring the developed image thus formed to a transfer body;
secondarily transferring the developed image thus primarily transferred to a predetermined recording medium;
cleaning the transfer body after the developed image is secondarily transferred to the recording medium;
forming a cleaning developed image on the photoreceptor outside of a paper feeding width and inside of a developing width in a rotational axis direction of the photoreceptor; primarily transferring the cleaning developed image thus formed to the transfer body; and
cleaning the cleaning developed image thus primarily transferred.
